(19) United States
(12) Patent Application Publication
(10) Pub. No.: US 2015/0019620 A1
(43) Pub. Date: Jan. 15, 2015

(54) HIGH AVAILABILITY FOR COMMUNICATIONS BASED ON REMOTE PROCEDURE CALLS

(71) Applicant: KAMINARIO TECHNOLOGIES LTD., Yokne'am Ilit (IL)

(72) Inventors: Elad Gidron, Haifa (IL); Idit Keidar, Haifa (IL); Doron Tal, Haifa (IL); Eyal Gordon, Haifa (IL)

(21) Appl. No.: 13/937,619

(22) Filed: Jul. 9, 2013

(51) Int. Cl. H04L 29/08

(52) U.S. Cl. CPC H04L 67/10
USPC 709/203

(57) ABSTRACT

Examples of disclosed subject matter relate to: a method, comprising: in an RPC client side: generating an RPC request which corresponds to an RPC call, the RPC request is addressed to an RPC server side and the RPC request includes an RPC call ID; logging the RPC request in an entry that includes an ID of the RPC call; in the RPC server side, responsive to receiving the RPC request: logging the RPC request in an entry including the ID of the RPC call; generating a respective RPC reply that is addressed to the RPC client side and the RPC reply includes the ID of the RPC call; logging the RPC reply in the entry that includes the ID of the RPC call; and in the RPC client side, responsive to receiving the RPC reply: logging the RPC reply in the entry that includes the ID of the RPC call.

### FIELD OF THE INVENTION

The present invention is in the field of communications and relates to highly available communication of remote procedure calls.

### BACKGROUND

In distributed systems, one entity can request a service from another entity running in a different process, possibly on a different machine. In such an interaction, the requesting entity may act as a client, and the replying entity can act as a server. The same entity can act as a client in one interaction, and as a server in another. A common model for such client-server interactions uses a remote procedure call (RPC), [Bruce Jay Nelson (May 1981). Remote Procedure Call. Xerox Palo Alto Research Center. PhD thesis], whereby the client invokes a procedure call (or a function) that runs on the server, and the server returns a reply to the client.

### SUMMARY

Many of the functional components of the presently disclosed subject matter can be implemented in various forms, for example, as hardware circuits comprising custom VLSI circuits or gate arrays, or the like, as programmable hardware devices such as FPGAs or the like, or as a software program code stored on any tangible computer readable medium and executable by various processors, and any combination thereof. A specific component of the presently disclosed subject matter can be formed by one particular segment of software code, or by a plurality of segments, which can be joined together and collectively act or behave according to the presently disclosed limitations attributed to the respective component. For example, the component can be distributed over several code segments such as objects, procedures, and functions, and can originate from several programs or program files which operate in conjunction to provide the presently disclosed component.

In a similar manner, a presently disclosed component(s) can be embodied in operational data or operational data can be used by a presently disclosed component(s). By way of example, such operational data can be stored on any tangible computer readable medium. The operational data can be a single data set, or it can be an aggregation of data stored at different locations, on different network nodes or on different storage devices.

According to an aspect of the presently disclosed subject matter, there is provided a method which uses a messaging infrastructure that can be implemented in a distributed system. According to examples of the presently disclosed subject matter, the method can include: in an RPC client side: generating an RPC request which corresponds to an RPC call, the RPC request is addressed to an RPC server side and the RPC request includes an RPC call ID; logging the RPC request in an entry that includes an ID of the RPC call; in the RPC server side, responsive to receiving the RPC request: logging the RPC request in an entry including the ID of the RPC call; generating a respective RPC reply that is addressed to the RPC client side and the RPC reply includes the ID of the RPC call; logging the RPC reply in the entry that includes the ID of the RPC call; and in the RPC client side, responsive to receiving the RPC reply: logging the RPC reply in the entry that includes the ID of the RPC call.

According to examples of the presently disclosed subject matter, further in response to receiving the RPC reply further including: in an RPC client side: communicating an RPC acknowledgement to the RPC server side including the ID of the RPC call; and in the RPC server side, responsive to receiving the RPC acknowledgement: logging the RPC acknowledgment in the entry that includes the ID of the RPC call.

B way of example, the RPC client side and the RPC server side can be functional entities in a distributed storage system, and the RPC call can be a storage command.

Further by way of example, in case an RPC call is designated as non-persistent, the logging operations can be skipped for that RPC call.

Yet further by way of example, wherein in case the RPC call includes an indication that a respective operation is an ordered operation, the entries associated with the ID of the RPC call can include an order indication.

According to examples of the presently disclosed subject matter, in case the RPC call is part of a transaction that includes a plurality of RPC calls: obtaining a context ID that is uniquely associated with the transaction; and including, in entries that include the ID of any one of the plurality of RPC calls which are part of the transaction, the context ID of the transaction.

According to yet further examples of the presently disclosed subject matter, in case the RPC call is part of a transaction: in the RPC client side: generating an RPC request which corresponds to the RPC call, the RPC request is addressed to an RPC server side and the RPC request includes an RPC call ID and a client context ID that is uniquely associated, on the RPC client side, with the transaction which the RPC call is part of; logging the RPC request in an entry that includes the ID of the RPC call and the client context ID; in the RPC server side, responsive to receiving the RPC request: logging the RPC request, the client context ID and the client context ID in an entry including the ID of the RPC call; generating a respective RPC reply that is addressed to the RPC client side and the RPC reply includes the ID of the RPC call and a server context ID which is uniquely associated, on the RPC server side, with the transaction which the RPC call is part of; logging the RPC reply and the server context ID in the entry that includes the ID of the RPC call; and in the RPC client side, responsive to receiving the RPC reply: logging the RPC reply and the server context ID in the entry that includes the ID of the RPC call.

According to an aspect of the presently disclosed subject matter, there is provided a system which uses a messaging infrastructure that can be implemented in a distributed system. According to examples of the presently disclosed subject matter, the system can include an RPC client side and an RPC server side running in different processes, a client temporary storage, and a server temporary storage. The RPC client side can be configured to generate an RPC request, the RPC request corresponding to an RPC call, the RPC request is addressed to an RPC server side and includes an ID of the RPC call. The RPC client side can be configured to log the RPC request in an entry in the client temporary storage that includes the ID of the RPC call. The RPC server side can be capable of responding to receiving the RPC request by: logging the RPC request in an entry in the server temporary storage that includes the ID of the RPC call; generating a respective RPC reply that is addressed to the RPC client side and the RPC reply includes an ID of the RPC call; logging the RPC reply in the entry in the server temporary storage that includes the ID of the RPC call. The RPC client side can be responsive to receiving the RPC reply for: logging the RPC reply in the entry in the client temporary storage that includes the ID of the RPC call.

According to examples of the presently disclosed subject matter, the RPC client side can be further responsive to receiving the RPC reply for communicating an RPC acknowledgement to the RPC server side including the ID of the RPC call. The RPC server side can be responsive to receiving the RPC acknowledgement for logging the acknowledgement in the entry in the server temporary storage that includes the ID of the RPC call.

According to examples of the presently disclosed subject matter, the RPC client side can be implemented in a FE of the storage system, and the RPC server side can be implemented in a BE of the storage system. In further examples of the presently disclosed subject matter, the RPC client side can be implemented in a first BE node of the storage system, and the RPC server side can be implemented in a second BE node of the storage system.

According to examples of the presently disclosed subject matter, in case an RPC call is designated as non-persistent, the RPC client side and the RPC server side can be configured to skip the logging operations for that RPC call.

According to examples of the presently disclosed subject matter, in case the RPC call includes an indication that a respective operation is an ordered operation: the RPC client side can be configured to include in the RPC request an ordered indication, and to include an ordered indication in log entries, in the client temporary storage, which are associated with the RPC call. The RPC server side can be configured to include in the respective RPC reply an ordered indication, and to include an ordered indication in log entries, in the server temporary storage, which are associated with the RPC call.

According to examples of the presently disclosed subject matter, in case the RPC call is part of a transaction that includes a plurality of RPC calls: the RPC client side can be configured to include in the RPC request a context ID that is uniquely associated with the transaction which the RPC call is part of, and to include the context ID in log entries, in the client temporary storage, which are associated with the RPC call. The RPC server side can be configured to include in the respective RPC reply a context ID, and to include the context ID in log entries, in the server temporary storage, which are associated with the RPC call.

According to examples of the presently disclosed subject matter, in case the RPC call is part of a transaction: the RPC client side can be configured to: generate an RPC request which corresponds to the RPC call, the RPC request is addressed to an RPC server side and the RPC request includes an RPC call ID and a client context ID that is uniquely associated, on the RPC client side, with the transaction which the RPC call is part of; log the RPC request in an entry that includes the ID of the RPC call and the client context ID. Responsive to receiving the RPC request, the RPC server side can be configured to: log the RPC request, the client context ID and the client context ID in an entry including the ID of the RPC call; generate a respective RPC reply that is addressed to the RPC client side and the RPC reply includes the ID of the RPC call and a server context ID which is uniquely associated, on the RPC server side, with the transaction which the RPC call is part of; log the RPC reply and the server context ID in the entry that includes the ID of the RPC call. Responsive to receiving the RPC reply, the RPC client side can be configured to: log the RPC reply and the server context ID in the entry that includes the ID of the RPC call.

In yet another aspect of the presently disclosed subject matter, there is provided a program storage device readable by machine, tangibly embodying a program of instructions executable by the machine to perform a method according to examples of the presently disclosed subject matter. According to examples of the presently disclosed subject matter, the program of instructions executable by the machine can include: in an RPC client side: generating an RPC request which corresponds to an RPC call, the RPC request is addressed to an RPC server side and the RPC request includes an RPC call ID; logging the RPC request in an entry that includes an ID of the RPC call; in the RPC server side, responsive to receiving the RPC request: logging the RPC request in an entry including the ID of the RPC call; generating a respective RPC reply that is addressed to the RPC client side and the RPC reply includes the ID of the RPC call; logging the RPC reply in the entry that includes the ID of the RPC call; and in the RPC client side, responsive to receiving the RPC reply: logging the RPC reply in the entry that includes the ID of the RPC call.

In yet another aspect of the presently disclosed subject matter, there is provided a computer program product comprising a computer useable medium having computer readable program code embodied therein. According to examples of the presently disclosed subject matter, the computer program product can include: in an RPC client side, computer readable program code for causing the computer to: generate an RPC request which corresponds to an RPC call, the RPC request is addressed to an RPC server side and the RPC request includes an RPC call ID; log the RPC request in an entry that includes an ID of the RPC call; in an RPC server side, computer readable program code responsive to receiving the RPC request at the in an RPC server side for causing the computer to: log the RPC request in an entry including the ID of the RPC call; generate a respective RPC reply that is addressed to the RPC client side and the RPC reply includes the ID of the RPC call; log the RPC reply in the entry that includes the ID of the RPC call; and in the RPC client side, computer readable program code responsive to receiving the RPC reply for causing the computer to: log the RPC reply in the entry that includes the ID of the RPC call.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram illustration of one possible implementation of a system, according to examples of the presently disclosed subject matter;

FIG. 2 is a flowchart illustration of a method according to examples of the presently disclosed subject matter, which uses a messaging infrastructure that can be implemented in a distributed storage system to provide highly available RPC based communications;

FIG. 3 is a call flow diagram illustrating communications that occur during the process of FIG. 2, according to examples of the presently disclosed subject matter;

FIG. 4 is a flowchart illustration of a method according to examples of the presently disclosed subject matter, which uses a messaging infrastructure that can be implemented in a distributed storage system to provide highly available RPC based communications including a feature that supports transactions that are associated with a plurality of RPC calls;

FIG. 5 is an illustration of an example of a use of a client context ID and a server context IDS as part of the messaging infrastructure, according to examples of the presently disclosed subject matter, is depicted in;

FIG. 6 is an illustration of a use of delayed context as part of a messaging infrastructure, according to examples of the presently disclosed subject matter; and

FIG. 7 is an illustration of a use of an exclusive operation as part of a messaging infrastructure, according to examples of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without some of these specific details. In other instances, well-known methods, procedures and components have not been described in detail so as not to obscure the presently disclosed subject matter.

Unless specifically stated otherwise, as apparent from the following discussions, it is appreciated that throughout the specification various functional terms refer to the action and/or processes of a computer or computing device, or similar electronic computing device, that manipulate and/or transform data represented as physical, such as electronic, quantities within the computing device's registers and/or memories into other data similarly represented as physical quantities within the computing device's memories, registers or other such tangible information storage, memory, transmission or display devices.

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

As used herein, the terms “example”, “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

The operations in accordance with the teachings herein may be performed by a computer specially constructed for the desired purposes or by a general purpose computer specially configured for the desired purpose by a computer program stored in a non-transitory computer readable storage medium.

Embodiments of the presently disclosed subject matter are not described with reference to any particular programming language. It will be appreciated that a variety of programming languages may be used to implement the teachings of the presently disclosed subject matter as described herein.

Unless specifically stated otherwise, as apparent from the following discussions, it is appreciated that throughout the specification discussions utilizing terms such as “processing”, “obtaining”, “utilizing”, “determining”, “generating”, “setting”, “configuring”, “selecting”, “searching”, “receiving”, “storing” or the like, include actions and/or processes of a computer that manipulate and/or transform data into other data, said data represented as physical quantities, e.g., such as electronic quantities, and/or said data representing the physical objects. The terms “computer”, “processor”, and “controller” should be expansively construed to cover any kind of electronic device with data processing capabilities.

According to an aspect of the presently disclosed subject matter, there is disclosed a method, comprising: in an RPC client side: generating an RPC request which corresponds to an RPC call, the RPC request is addressed to an RPC server side and the RPC request includes an RPC call ID, and logging the RPC request in an entry including an ID of the RPC call; in the RPC server side, responsive to receiving the RPC request: logging the RPC request in an entry including the ID of the RPC call, e.g., obtained from the RPC request, generating a respective RPC reply that is addressed to the RPC client side and the RPC reply includes an ID of the RPC call, and logging the RPC reply in the entry including the ID of the RPC call; and in the RPC client side, responsive to receiving the RPC reply: logging the RPC reply in the entry including the ID of the RPC call, e.g., obtained from the RPC reply.

According to examples of the presently disclosed subject matter, the method can further include: in the RPC client side, responsive to receiving the RPC reply, communicating an RPC acknowledgement to the RPC server side including the RPC ID of the RPC call, e.g., that is obtained from the RPC reply; and in the RPC server side, responsive to receiving the RPC acknowledgement, logging an indication that an RPC acknowledgment was received in the entry including the ID of the respective RPC call.

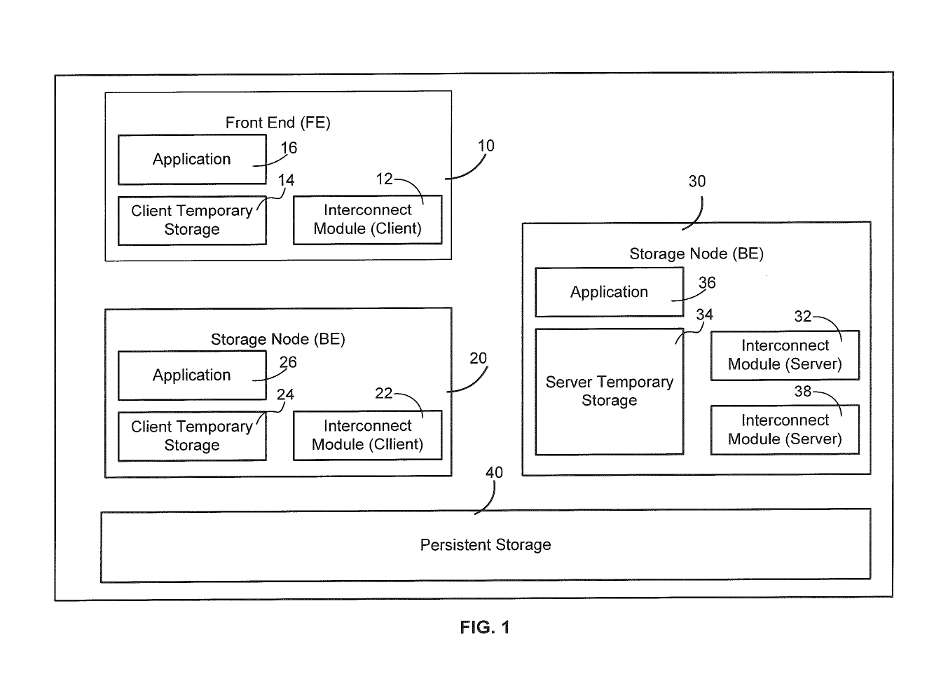

Reference is now initially made to FIG. 1, which is a block diagram illustration of one possible implementation of a system, according to examples of the presently disclosed subject matter. The system shown in FIG. 1, and described herein with reference to FIG. 1, is a distributed storage system 100. It would be appreciated that some examples of the presently disclosed subject matter are not necessarily limited to being implemented in a storage system. Rather, according to further examples of the presently disclosed subject matter, a system implementing the teachings according to examples of the presently disclosed subject matter can be any distributed system which utilizes digital communication among the distributed functional entities. Accordingly, some examples of the presently disclosed subject matter seek to provide a framework for implementing highly available communication of remote procedure calls in a distributed system.

Referring back to FIG. 1, the distributed storage system 100 includes a front end (“FE”) node 10, a first backend node (“BE”) 20 and a second BE node 30. The system 100 further includes persistent storage 40. The persistent storage 40 can be a shared persistent storage that is used by the plurality of nodes, as is shown by way of example in FIG. 1, or in other examples, each node can be associated with its own persistent data store. In the example shown in FIG. 1, the FE node 10 serves as a first RPC client side, the first BE node 20 serves as a second RPC client side, and the second BE node 30 serves as a first RPC server side and a as second RPC server side, where the first RPC server side, and the second RPC server side are two distinct entities running on the same machine and connected to different RPC clients. In the example shown in FIG. 1, the first server side is interconnected with the first RPC client side, and the second RPC server side is interconnected with the second RPC client side. It would be appreciated that it is possible to implement in each node just one client or server entity and that it is also possibly to implement in one or more nodes a plurality of client and/or server entities. It would be appreciated that in distributed systems, such as system 100, it is common for one entity, e.g., the first RPC client side or the second RPC client side, to request a service from another entity running in a different process, e.g., the first RPC server side and the second RPC server side, respectively, possibly on a different machine.

For example, in a distributed storage system, such as system 100, the FE node 10 can act as a first RPC client and invoke a read (or write) RPC to request to read (or write) a certain data item from storage nodes (BE) 30, which would act as a first RPC server that is interconnected with the first RPC client. As is shown in FIG. 1, one BE node 20 can also serve as a client, the second RPC client, when the BE node 20 is requesting a service (e.g., requesting to read or write data) from another BE node 30, which also implements a second RPC server that is interconnected with the second RPC client.

Another example of entities in a distributed system which can utilize RPC communication relates to entities in a system that employs deduplication. In such a system there can exist an indexing entity that maps data contents to their respective locations. In such a system, a storage node (e.g., say BE node 20) can be requested to store a new data block. In response to the instruction to store the new data block, the storage node can be configured to access the indexing entity in order to check whether the content of this block is already stored in the system, in which case the storage node can be configured to store only a pointer to data that is already stored in the system, rather than allocate storage resources and store the entire contents anew. In this interaction, the storage node can serve as a client, and the index entity as a server. The storage node can be configured to invoke a lookup RPC to query the indexing entity about the whereabouts of the content of the new data block, and to increase its reference count if the content of the new data block already exists in the storage system.

It would be appreciated that the RPC model can simplify programming of a distributed system, as it allows requests to a remote server to be treated much like regular (local) function calls. It would also be noted, that using RPC can introduce the problem of failure independence. In this regard, it would be noted that unlike a local function call, which occurs within one particular process that executes both the call and the called function, in an RPC, the called function is executed on a different process, possibly even on a different machine. Hence, the function's execution can fail independently of the calling entity. Moreover, even if neither entity fails, the communication between the two entities can fail, a message could be lost, and so on. In case of failure, information could be lost, and inconsistencies between the client and server states could arise as RPC calls may be partially executed. The situation is exacerbated by the fact that, in many cases, in order to improve efficiency, entities (both clients and servers) perform operations in volatile memory, without persisting the operation to disk. For example, a server entity can reply to a remote procedure call before logging the effect of performing the call to persistent, non-volatile storage. Thus, in case of a server crash, information pertaining to the call could be lost even after the client received a reply to the client's request.

As mentioned above, some examples of the presently disclosed subject matter seek to provide a framework for implementing highly available communication of remote procedure calls in a distributed system. The term “high availability” and similar terms are referenced throughout the description and in the claims. The term high availability is known in the art of distributed systems, and the following definition is provided as a non-limiting example only for convenience purposes. Accordingly, the interpretation of the term high availability in the claims, unless stated otherwise, is not limited to the definitions below and the term high availability should be given its broadest reasonable interpretation. The term high availability as used herein relates to a system design and implementation that ensures that a service remains available (that is, both active and correct) despite a pre-defined set of potential failures. The set of allowed failures can be specified so as to achieve a bound on system downtime. For example, consider a system with three servers. If the probability that two of the three servers are simultaneously un-operational is 0.001, then a system that remains available despite the failure of one of them will achieve so-called three nines of availability, that is, it will be operational 0.999 of the time.

Note that the calculation above is somewhat simplified, as it implicitly assumes that the system is capable of tolerating a new failure immediately once a new (or previously faulty) server is brought up. In practice, however, the system performs a failure recovery process once a new server is added (or re-added following a crash). The failure recovery period is typically a window of vulnerability, where an additional failure may render the system unavailable. Therefore, highly available systems are typically designed to allow for quick recovery from failures, so as to keep the window of vulnerability short. Likewise, a highly available system can be designed with capabilities of avoiding data loss even in case of more severe failures (for example, two simultaneous failures), so as to re-ensure availability after these failures are mended.

In order to achieve high availability distributed systems require redundancy. A service provided by multiple entities can remain operational when one of the entities which provide the service fails; likewise, data redundantly stored at multiple entities can maintain accessibility despite failure in one of the entities.

With this in mind, the description is now resumed with reference to FIG. 1. According to examples of the presently disclosed subject matter, each of the first and second RPC client sides and each of the first and second RPC server sides can be associated with an interconnect module. Each of the first and second RPC client sides and each of the first and second RPC server sides can be further associated with a temporary storage module and with an application. For example, the FE node 10 on which a first RPC client side is implemented includes an interconnect module 12, a client temporary storage 14 and an application 16. The BE node 20 on which a second RPC client side is implemented also includes an interconnect module 22, a client temporary storage 24 and an application 26. The BE node 30 on which both the first RPC server side and the second RPC server side are implemented includes an interconnect module 32 which is associated with the first RPC server side and another interconnect module 38, which is associated with the second RPC server side. The BE node 30 further includes a server temporary storage 34 and an application 36, which in this example are associated with both the first RPC server side and with the second RPC server side.

According to examples of the presently disclosed subject matter, the interconnect modules 12, 22,32 and 38 both on the client sides and on the server sides are configured to establish a highly available interconnect channel between the respective nodes. For example, in the example scenario illustrated in FIG. 1, the interconnect modules 12 and 32 are configured to establish highly available interconnect channel between node 10 and 30, and the interconnect modules 22 and 38 are configured to establish a highly available interconnect channel between node 20 and 30.

The interconnect modules 12, 22,32 and 38 can control and manage the communications over the respective interconnect channels. The interconnect modules 12, 22, 32, 38 can be configured to use a predefined enhanced RPC messaging infrastructure or an application programming interface (“API”) to control and manage the communications over the respective interconnect channels. For convenience throughout the description and in the claims the terms messaging infrastructure and API are used interchangeably.

According to examples of the presently disclosed subject matter, the interconnect modules 12, 22, 32 and 38 both on the RPC client side and on the server side are configured to support and utilize an API which is based on the RPC API with added features, including features which support high availability in a distributed system, as will be described herein. By way of example, the API which is implemented by the interconnect modules 12, 22, 32 and 38 supports logging of in-flight request and replies, which are replicated at either side (the client side and the server side) of the channel.

According to further examples of the presently disclosed subject matter, interconnect modules 12, 22, 32 and 38 can implement an enhanced RPC API which, in addition to the features that support high availability in a distributed system, has features that support continued high availability of RPC requests and respective RPC replies until both the RPC client side associated with the RPC request and the RPC server side that issued the RPC reply explicitly acknowledge having the effects of the operations associated with the RPC request and/or reply and/or acknowledgment being recorded or reflected in data that is stored in the persistent storage.

Optionally, according to yet further examples of the presently disclosed subject matter, the API supported and utilized by the interconnect modules 12, 22, 32 and 38 can include other additional features as well, as will be further described herein.

According to examples of the presently disclosed subject matter, the interconnect modules 12, 22, 32 and 38 can be implemented as a service running on standard or application specific computer hardware.

In this regard, it would be appreciated that standard RPC can present the problem of failure independence. Unlike a local function call that occurs within one particular process that executes both the call and the called function, in an RPC, the called function is executed on a different process, possibly even on a different machine. Hence, the function's execution can fail independently of the calling entity. Moreover, even if neither entity fails, the communication between the two could experience failures, message loss, and so on. In cases of failures, information could be lost, and inconsistencies between the client side and server side states may arise as RPC calls could be only partially executed.

According to examples of the presently disclosed subject matter, the term “application” as used herein, can relate to a computer readable program code embodied in computer readable medium, specifically a tangible computer readable medium. For example, the application can reside in a computer's memory unit and can be executed by a processor of the computer to carry out the operations described herein with reference to the application. In other examples of the presently disclosed subject matter, the term “application” as used herein, can relate to a program of instructions embodied in a storage device readable by machine, where the program of instructions is executable by the machine to perform the operations which are described herein with reference to the application.

According to examples of the presently disclosed subject matter, the temporary storage modules 14, 24 and 34 in the various nodes can be non-volatile store, which are capable of surviving power failures. In further examples of the presently disclosed subject matter, the temporary storage modules 14, 24 and 34 in the various nodes can be volatile storage units. In still further examples of the presently disclosed subject matter, one of the temporary storage modules among a pair of temporary storage modules (one in each of the RPC client side and in the RPC server side) nodes can be volatile store, and the other can be non-volatile store. For example, NVRAM or battery protected memory or other non-volatile storage devices such as SSD can be used. Further according to examples of the presently disclosed subject matter, the memory or storage medium of the temporary storage modules 14, 24 and 34 can be encapsulated in a service that provides a key-value store abstraction. By way of example, the temporary storage modules 14, 24 and 34 can be used to maintain data highly available, until the application 16, 26, and 36, respectively indicates that the data was persisted (e.g., it was stored in the persistent storage 40).

According to examples of the presently disclosed subject matter, the temporary storage modules 14, 24 and 34 can reside at the same location (in the same node) as the respective interconnect module 12, 22, 32 and 38, or in further examples of the presently disclosed subject matter, one or more temporary storage modules can be implemented as remote temporary storage entities. For example, when an RPC client side and an RPC server side are implemented on the same machine (i.e., on the same node) one of the RPC client side or the RPC server side implemented on the same machine can be configured to use a remote temporary storage entity.

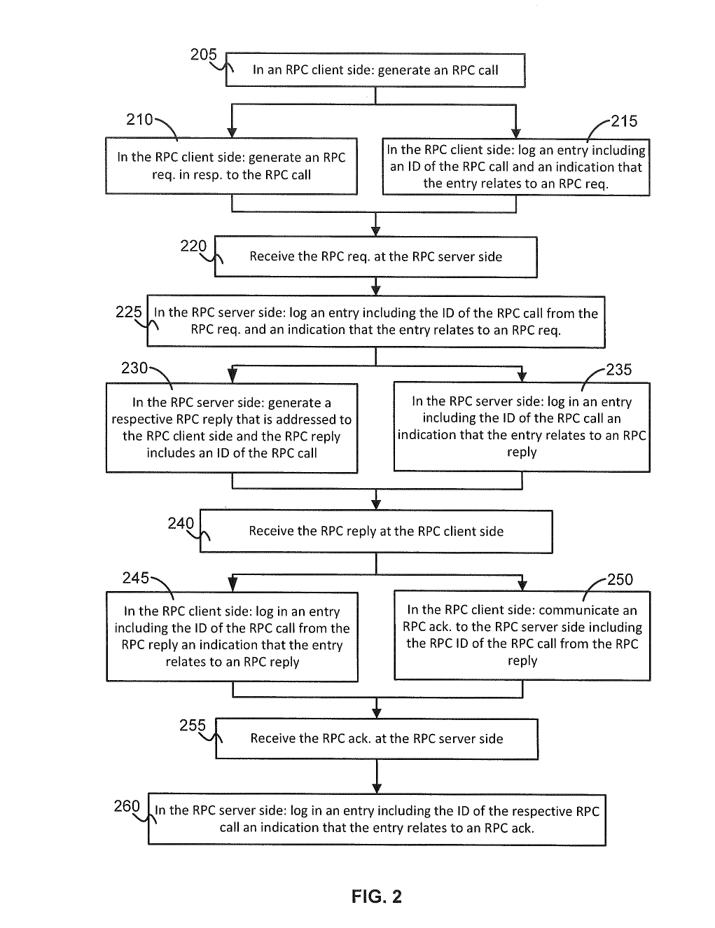

Reference is now made to FIG. 2, which is a flowchart illustration of a method according to examples of the presently disclosed subject matter, which uses a messaging infrastructure that can be implemented in a distributed storage system to provide highly available RPC based communications. For convenience the description of the operations in FIG. 2 is made with reference to components of the system 100 in FIG. 1. It should be noted however, that the operations shown in FIG. 2, and described here with reference to FIG. 2 are not necessarily limited in implementation to the components of the system 100 in FIG. 1, and that other system designs and configurations can possibly be used to carry out the operations shown in FIG. 2, and described here with reference to FIG. 2.

According to examples of the presently disclosed subject matter, in an RPC client side an RPC call can be generated (block 205). For example, an application 16 running in the FE node 10 (which servers here as the client side) can generate a RPC call.

According to examples of the presently disclosed subject matter, the RPC call that was generated by the application 16 running in the FE node 10 can be fed to the interconnect module 12 of the FE node 10. According to examples of the presently disclosed subject matter, the server to which the RPC call is addressed can be specified in the RPC call. In still further examples of the presently disclosed subject matter, the interconnect module 12 can be configured for providing a communication channel between a particular, predefined, client-server pair. Thus, for example, the interconnect module 12 can be configured to provide a communication channel between the FE node 10 and the BE node 30, and specifically between the interconnect module 12 and the interconnect module 32. It would be appreciated that in case of this implementation, one or more nodes in a distributed system can have a plurality (two, three, . . . , n) of interconnect modules, where each interconnect module can be associated with a different communication channel and with a different client-server pair.

According to examples of the presently disclosed subject matter, in the client side, in response to the RPC call, an RPC request can be provided, where the RPC request includes an ID of the corresponding RPC call, the function call and the parameters from the RPC call and is addressed to the RPC server side to which the RPC call was addressed (block 210), and further in the RPC client side, the RPC request can be logged with a reference to the ID of the RPC call with which the RPC request is associated (block 215). For convenience, throughout the description and in the claims, a reference made to an RPC request implies that the RPC request includes at least the function call and the parameters from the respective RPC call.

As mentioned above, by way of example, the RPC call that was generated by the application 16 can be fed to the interconnect module 12, and the interconnect module 12 can be configured to provide a corresponding RPC request. The RPC request that is provided by the interconnect module 12 can include an ID of the corresponding RPC call.

By way of example, the ID of the RPC call can be provided by the interconnect module 12. Further by way of example, the ID of the RPC call can be generated by the interconnect module 12. Still further by way of example, the ID of the RPC call can be globally unique across the distributed storage system 100. In a further example, the unique ID of the RPC call can be generated by the application 16. Yet further by way of example, the ID of the RPC call can be a combination of a globally unique identifier of the node 10 on which the interconnect module is residing (e.g., a MAC address of the node) and a locally unique ID of the RPC call. In another example, the ID of the RPC call can be a combination of a globally unique identifier of the node 10 on which the interconnect module 12 is residing (e.g., a MAC address of the node), a locally unique identified of the interconnect module 12, and a locally unique ID of the RPC call. In yet a further example, it is sufficient that the ID of the RPC call be unique per connection or channel.

According to examples of the presently disclosed subject matter, further in response to an RPC call, the interconnect module 12 can be configured to cause the local temporary storage 14 to store the RPC request in an entry that includes the ID of the RPC call.

The RPC request from the RPC client side can be received at an RPC server side (block 220) to which the RPC request was addressed. In response to receiving the RPC request at the RPC server side, in the RPC server side, the RPC request can be logged with a reference to the ID of the RPC call with which the RPC request is associated (block 225). For example, assuming that the RPC request from the FE node 10 was addressed to BE node 30, the RPC request is received at the interconnect module 32. The interconnect module 32 can be configured to cause the local temporary storage 34 to store the RPC request in an entry that includes the ID of the RPC call.

According to examples of the presently disclosed subject matter, further in response to receiving the RPC request at the RPC server side, in the RPC server side, an RPC reply that corresponds to the RPC request can be generated, where the RPC reply is addressed to the RPC client side from which the corresponding RPC request was received, and the RPC reply includes an ID of the RPC call (block 230), and further in the server side, the RPC reply can be logged in an entry including the ID of the RPC call with which the RPC reply is associated (block 235). It would be appreciated that the RPC reply includes the response that was generated by the application on the RPC server side.

According to examples of the presently disclosed subject matter, when the interconnect module 32 receives the RPC request from the interconnect module 12 of the FE node 10 (the client side), the interconnect module 32 can be configured to generate a function call on the RPC server side based on the received RPC request, to invoke the respective function in the application 36. The application 36 on the RPC server side can be configured to generate a reply to the RPC request. By way of example, the application 36 can be configured to generate a callback in response to the RPC call from the interconnect module 32, and the callback includes the ID of the RPC call with which it is associated. According to examples of the presently disclosed subject matter, if the RPC channel (the channel over which the RPC client side and the RPC server side are communicating) is synchronous, the RPC call ID for the callback can be derived from the context. The RPC reply can be fed to the interconnect module 32 which reads the RPC call ID from the RPC reply (this is the same RPC call ID that was included in the respective RPC request) or derives it from the context in case of a synchronous channel, and the interconnect module 32 can be configured to cause the local temporary storage 34 to store the RPC reply in the entry which includes the ID of the RPC call.

The interconnect module 32 at the RPC server side can be configured to communicate the RPC reply to the RPC client side, where it can be received by the corresponding interconnect module 12 (block 240). According to examples of the presently disclosed subject matter, upon receiving the RPC reply at the RPC client side the interconnect module 12 can be configured to cause the local temporary storage 14 to store the RPC reply in the entry which includes the ID of the RPC call (block 245). The interconnect module 12 at the RPC client side, can be further responsive to receiving the RPC reply from the server side, for communicating an RPC acknowledgment to the RPC server side including the RPC ID of the RPC call (block 250).

According to examples of the presently disclosed subject matter, the interconnect module 12 can be configured to pass on the reply that was received from the RPC server side to a local application 16. For example, the reply is passed on to the application that generated the RPC call. It would be appreciated that the interconnect modules at the RPC client side and at the RPC server side can be configured to marshal and demarshal RPC requests, replies and acknowledgments, as appropriate.

The acknowledgment from the RPC client side can be communicated to the RPC server side, where it can be received by the respective interconnect module 32 (block 255). Optionally, at the RPC server side: the interconnect module 32 can be configured to cause the local temporary storage 34 to store the RPC acknowledgment in the entry that includes the ID of the RPC call (block 260).

It would be appreciated that in a system where the above messaging infrastructure is implemented, the operations or communications with which the RPC calls are associated can be made highly available, and in case a node fails, its data can be recovered or restored using the data from the local temporary storage of a peer node possibly in combination with data in the persistent storage.

According to examples of the presently disclosed subject matter, at some point the data in the local temporary storage units can be destaged to the persistent storage 40. Further according to examples of the presently disclosed subject matter, a garbage collection process can be implemented in the system to reclaim storage resource in the local temporary storage units used for storing data that has already been safely destaged to the persistent storage 40.

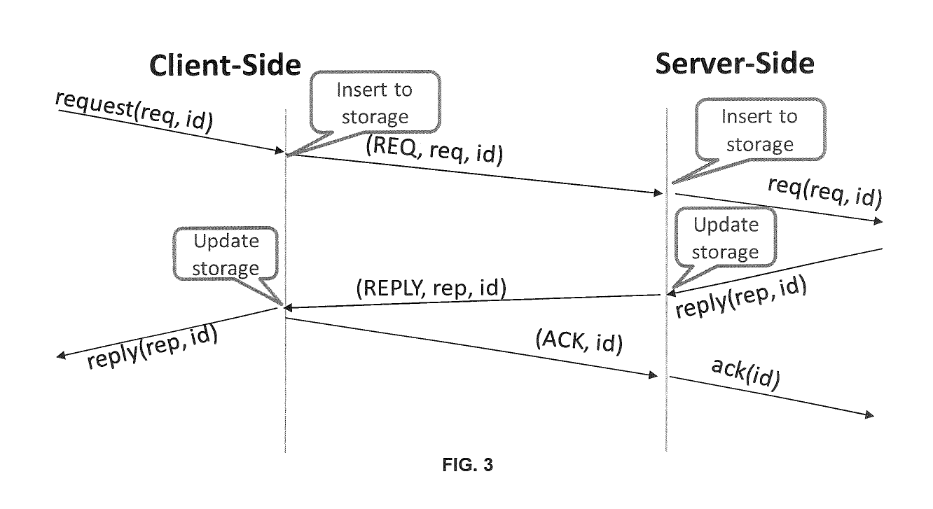

Reference is now made to FIG. 3, which is a call flow diagram illustrating communications that occur during the process of FIG. 2, according to examples of the presently disclosed subject matter. The communications in FIG. 3 are self explanatory in view of the above description of FIG. 2.

Table 1 below provides an example of a data structure that can be implemented in the RPC client side to store the RPC client side data logs mentioned above. It would be appreciated that any suitable data structure can be used to store the data. According to examples of the presently disclosed subject matter, the Call ID field can serve as the key field. Further by way of example, the Call ID field can hold the IDs of all the RPC calls for which data is currently stored in the RPC client side, specifically in the client side temporary storage. The Request field holds the RPC request that was communicated to the RPC server side. The Reply field holds, in the context of a given RPC call, an RPC reply received at the RPC client side.

TABLE 1

| | | |
|---|---|---|
| Call ID | Request | Reply |

Table 2 below provides an example of a data structure that can be implemented in the RPC server side to store the RPC server side data logs mentioned above. It would be appreciated that any suitable data structure can be used to store the data. According to examples of the presently disclosed subject matter, the Call ID field can serve as the key field. Further by way of example, the call ID field can hold the IDs of all the RPC calls for which data is currently stored in RPC server side, specifically in the server side temporary storage. The request field holds the RPC request referencing the respective RPC call ID that was received at the RPC server side. The reply field holds, in the context of a given RPC call, the RPC reply that was communicated from the RPC server side to the RPC client side. The RPC ACK field holds the indication that an acknowledgement was received in the RPC server side, indicating successful receipt of a RPC reply at the RPC client side, all of which is in the entry referencing the respective RPC call ID. In some examples of the presently disclosed subject matter, the ACK field can be omitted from the RPC server side data structure, and is thus optional. In case the RPC server side data structure is implemented without the ACK field, the format of data structure in the RPC server side and the format of the data structure in the RPC client side can be identical. It would be appreciated that the ACK field in the ensuing examples of the RPC server side data structure can also be optional.

TABLE 2

| | | | |
|---|---|---|---|
| Call ID | Request | Reply | ACK |

It would be appreciated that in some types of distributed systems, there may exist different types of operations or communication, and that some types of operations or communications may not require or necessitate persistency. According to examples of the presently disclosed subject matter, the application of the messaging infrastructure (or the enhanced API) can be selectively implemented with respect to some types of operations or communications, and with respect to other types of operations or communications a different or a subset of the messaging infrastructure can be implemented. Thus, according to examples of the presently disclosed subject matter, in case an RPC call is designated as non-persistent, the logging operations in the client side and in the server side are skipped for that RPC call.

For example, in a distributed storage system, there may exist some operations that need to be persistent because they update the storage (typically write operations), and other operations, e.g., operations that do not change the system's state, do not require persistency (typically read or query operations).

According to examples of the presently disclosed subject matter, the messaging infrastructure can include a feature that supports identification of a plurality of operations or communications in the distributed system that are part of a transaction or any other consistency group. For example, the messaging infrastructure can support a context ID, which can be associated with a plurality of calls and respective requests, replies and can be included in log entries corresponding to the requests, replies. In some examples of the presently disclosed subject matter, a context ID can be used by a garbage collection process to enable garbage collection of an entire group of log entries when the data is destaged to the persistent storage or is no longer required. According to examples of the presently disclosed subject matter, using the context ID the garbage collection element can be capable of using a single call to garbage collect all operations pertaining to a particular context ID.

For example, in case the RPC call is part of a transaction that includes a plurality of RPC calls, the RPC call can include or can be associated with a context ID that is uniquely associated with the transaction the RPC call is part of, and the logging of each of the RPC request entries and of the RPC reply entries associated with the RPC call can further include the respective context ID.

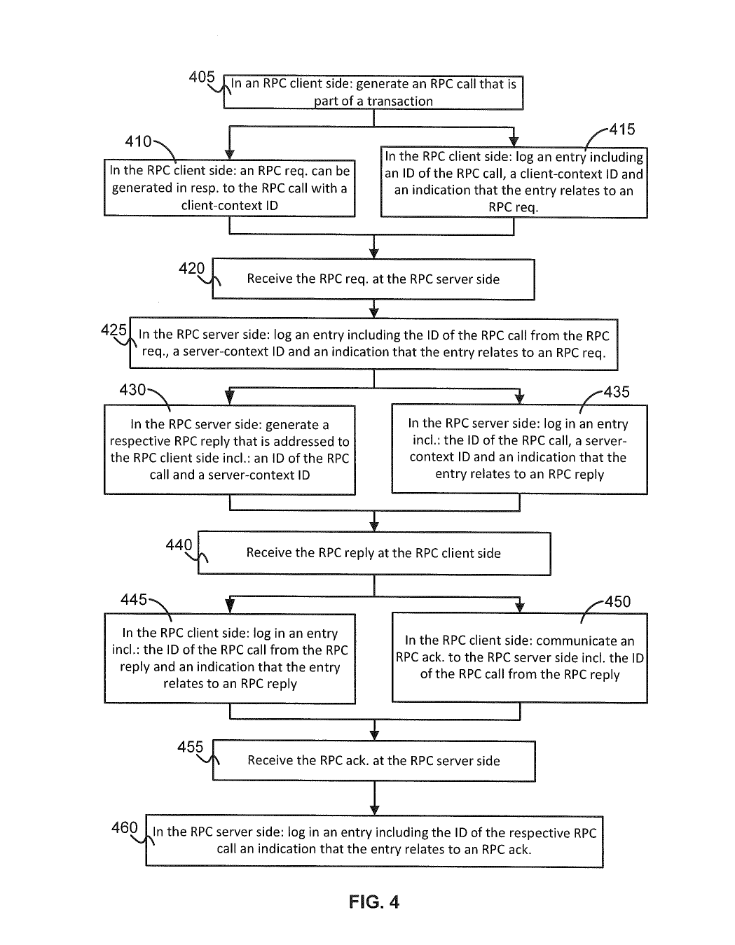

Reference is now made to FIG. 4, which is a flowchart illustration of a method according to examples of the presently disclosed subject matter, which uses a messaging infrastructure that can be implemented in a distributed storage system to provide highly available RPC based communications including a feature that supports transactions that are associated with a plurality of RPC calls. According to certain examples of the presently disclosed subject matter, in an RPC client side, an RPC call that is part of some transaction can be generated (block 405). The RPC call can be generated by a local application running in the RPC client side. The application can group multiple RPC operations and inform the local interconnect module that these operations belong to the same context, e.g., using a context ID. The RPC client side interconnect module can be configured to identify an RPC call as being part of a transaction when the RPC call includes or is associated with a transaction ID.

According to examples of the presently disclosed subject matter, the context ID can be locally unique. Thus for example, in the RPC client side, the context ID is a client-context ID, and in the RPC server side, the context ID is a server-context ID.

According to examples of the presently disclosed subject matter, in the client side, in response to the RPC call, an RPC request can be provided, where the RPC request includes an ID of the corresponding RPC call and a client-context ID (block 410). The RPC request is addressed to the RPC server side to which the RPC call was addressed. Further in the client side, the RPC request can be logged with the client-context ID in an entry which references the ID of the RPC call with which the RPC request is associated, (block 415).

The RPC request from the RPC client side can be received at a RPC server side (block 420) to which the RPC request was addressed. In response to receiving the RPC request at the server side, in the RPC server, the RPC request can be logged with a client-context ID in an entry which references the ID of the RPC call with which the RPC request is associated (block 425). As mentioned above, according to examples of the presently disclosed subject matter, the context ID can be locally unique.

According to examples of the presently disclosed subject matter, further in response to receiving the RPC request at the RPC server side, in the RPC server side, an RPC reply that corresponds to the RPC request can be generated, where the RPC reply is addressed to the RPC client side from which the corresponding RPC request was received, and the RPC reply includes an ID of the RPC call and a server-context ID (block 430), and further in the RPC server side, the RPC reply can be logged with the server-context ID in the entry including the reference to the ID of the RPC call with which the RPC reply is associated (block 435).

The RPC reply can be communicated to the RPC client side, and the RPC client side can receive the RPC reply (block 440). According to examples of the presently disclosed subject matter, upon receiving the RPC reply at the RPC client side, the reply can be logged at the RPC client side in an entry that includes the call ID that is referenced in the RPC reply (block 445). Optionally, further responsive to receiving the RPC reply, the RPC client side can be configured to communicate an RPC acknowledgment to the RPC server side, where the RPC acknowledgment communication includes the RPC ID of the respective RPC call (block 450).

The acknowledgment from the RPC client side can be communicated to the RPC server side (block 455). At the RPC server side the acknowledgment can be logged in an entry which includes the ID of the RPC call (block 460).

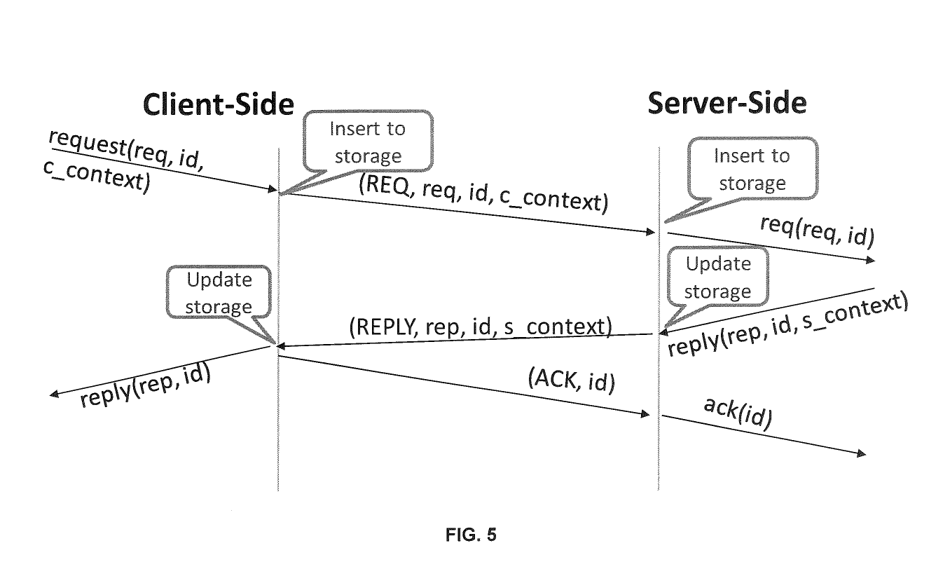

An example of the use of client context IDs and server context IDs as part of the messaging infrastructure, according to examples of the presently disclosed subject matter, is depicted in FIG. 5, and is self explanatory in view of the description of FIG. 4.

According to examples of the presently disclosed subject matter, the interconnect module at the RPC client side and at the RPC server side can be configured to maintain in the local temporary storage all the RPC call entries associated with a transaction, as long as any part of the transaction is needed to be maintained in the local temporary storage. An entry can be deleted from the temporary storage, on both the RPC client side and on the RPC server side, once all the entries (or their effects) with its client context entry are persisted on the RPC client side and all the entries (or their effects) with its server context are persisted on the RPC server side.

As mentioned above, according to examples of the presently disclosed subject matter, at some point the data in the local temporary storage units can be destaged to the persistent storage. The garbage collection process that can be implemented, as part of examples of the presently disclosed subject matter, can support a transaction clean feature, via which an entire group of entries in the local temporary storage can be deleted together.

According to examples of the presently disclosed subject matter, the context IDs described above can also be used in a recovery process. When a certain node fails, a get-all operation can be implemented with a reference to a certain context ID (client or server context), which allows a new (or recovering) entity to recover all pending messages that pertain to a certain context.

Table 3 below can be used in the RPC client side. Table 3 is similar to Table 1 above, with the addition of the client and server context fields that can be used to record the client context and the server context when the respective RPC call is part of a transaction, as was described above.

TABLE 3

| | | | | |
|---|---|---|---|---|
| Call ID | Request | Client | Reply | Server |
| | | Context | | Context |

Table 4 below can be used in the RPC server side. Table 4 is similar to Table 2 above, with the addition of the client and server context fields that can be used to record the client context and the server context when the respective RPC call is part of a transaction, as was described above.

TABLE 4

| | | | | | |
|---|---|---|---|---|---|
| Call ID | Request | Client | Reply | Server | Ack |
| | | Context | | Context | |

According to examples of the presently disclosed subject matter, the server context can be determined by the RPC server side some time after a reply is communicated from the RPC server side to the RPC client side. According to examples of the presently disclosed subject matter, the delayed server context can be used when an application must wait before it decides to which transaction it will add the request. For example, in a storage system certain operations (or all) can be buffered before the operations are included in a transaction to a persistent (stable) storage. In such a case, the context (e.g., transaction id) on the RPC server side can be determined after the reply to the RPC client side is ready to be communicated. According to examples of the presently disclosed subject matter, the messaging infrastructure, which can be implemented, for example, by the interconnect module, can be configured to support delayed contexts. When a channel is created between a RPC client side and a RPC server side, a configuration parameter can be provided to define whether or not delayed contexts are used in the channel. By way of example, the default can be not to use delayed context.

In the case a delayed context is invoked, the RPC server side can implement the functions: reply(rep, id, s_context1); addContext(id, s_context2); and clean(c_context2). By way of example, the RPC server side can be configured to implement an additional callback: ack1(id). Here, ackl is an early acknowledge, which acknowledges receipt of the reply only, whereas an actual acknowledge received by the RPC server side acknowledges receipt of both the reply and the additional context by the RPC client-side.

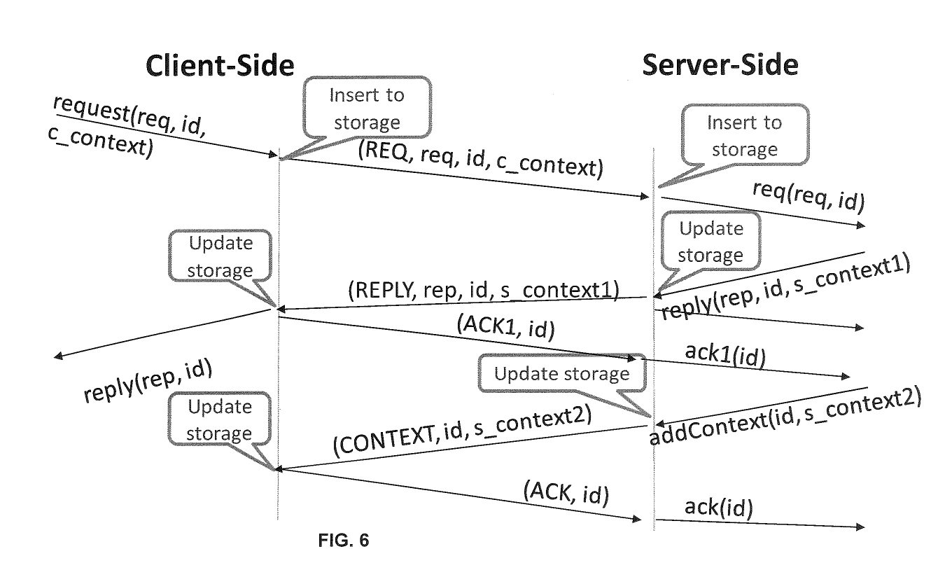

An example of the use of delayed context as part of the messaging infrastructure, according to examples of the presently disclosed subject matter, is depicted in FIG. 6. In the example shown in FIG. 6, an RPC client side sends an RPC request to an RPC server side (with an RPC client side context denoted c_context). The RPC server side buffers the request and associates some initial context with the request (denoted s_context1). The RPC server side later processes the request in the context of some transaction, at which point the RPC server side adds the transaction number as the delayed server-side context (denoted s_context2). According to examples of the presently disclosed subject matter, the delayed server-side context (s_context2) is logged in addition to the previous, provisional, RCP server side context (s_context1). According to examples of the presently disclosed subject matter, the RPC client side interconnect module and the RPC server side interconnect module can be configured to support a RPC delayed context communication, by which the RPC server side can update the RPC client side that a delayed server-side context side was added in the RPC server side in association with a certain RPC call. This delayed context RPC communication is referenced as CONTEXT in FIG. 6, and it is associated with the ID of the RPC call with which the delayed context function is associated and with the respective delayed server-side context reference. Further according to examples of the presently disclosed subject matter, the RPC client side module can be configured to reply to the delayed context RPC communication with an acknowledgement. The acknowledgment from the RPC client side can include the ID of the RPC call that was referenced in the delayed context RPC communication. In case the RPC client side or the RPC server side does not provide a context or provides a null context, the garbage collection is controlled exclusively by the other RPC side.

Table 5 below can be used in the RPC client side. Table 5 is similar to Table 3 above, with the addition of an additional server context field (Server context2) that can be used to record the delayed server-side context described above.

TABLE 5

| | | | | | |
|---|---|---|---|---|---|
| Call ID | Request | Client | Reply | Server | Server |
| | | context | | context | context2 |

Table 6, which is presented below can be used in the RPC server side. Table 6 is similar to Table 4 above with the addition of an additional server context field (Server context2) that can be used to record the delayed server-side context which was described above.

TABLE 6

| | | | | | | |
|---|---|---|---|---|---|---|
| Call | Request | Client | Reply | Server | Server | Ack |
| ID | | context | | context | context2 | |

The messaging infrastructure implemented by the method according to examples of the presently disclosed subject matter, and which can be implemented by the interconnect modules of the system according to examples of the presently disclosed subject matter, can include a feature that enables ordering of certain RPC calls relative to other operations. The ordering feature according to examples of the presently disclosed subject matter, can enable enforcement of partial order in the processing of the RPC call logs, which allows for parallelism in the processing of shared (non-ordered) operations, as will be apparent from the description below.

According to examples of the presently disclosed subject matter, by default, an RPC call and all the operations which are associated with the RPC call are considered to be shared (non-exclusive or non-ordered), and can be implemented (e.g., by the client side interconnect module and by the server side interconnect module) once the relevant operation is available with no regard for other operations or communications. Further according to examples of the presently disclosed subject matter, in case of recovery, replays of shared operations or communications can occur in a different order relative to the order by which these operations or communications were originally implemented. Still further according to examples of the presently disclosed subject matter, an RPC call and all the operations associated with the RPC call can be designated as exclusive, in which case all operations (both shared and exclusive) are ordered with respect to the RPC call designated as exclusive. That is, an operation associated with an RPC call that is designated as exclusive is delivered after an operation associated with an RCP call that is designated as shared (or which is not designated) if and only if it is invoked after the operation associated with an RCP call that is designated as shared.

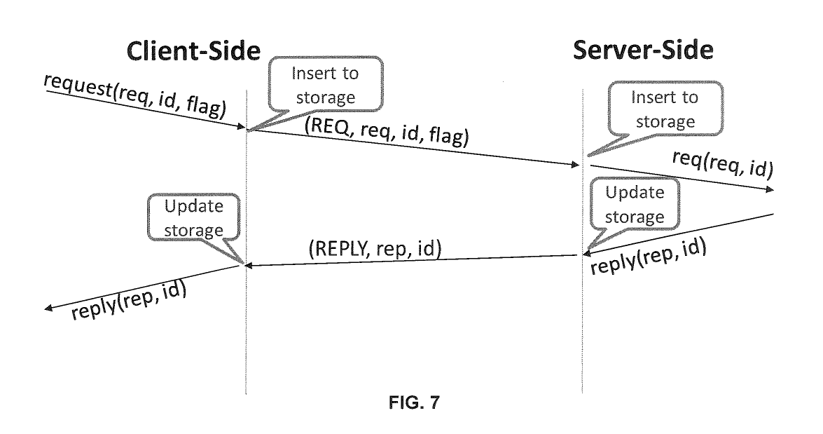

An example of the use of an exclusive operation as part of the messaging infrastructure, according to examples of the presently disclosed subject matter, is depicted in FIG. 7. In the example shown in FIG. 7, an RPC client side includes an exclusive flag in a RPC request to a RPC server side.

Table 7 below can be used in the RPC client side. Table 7 is similar to Table 3 above with the addition of an ordered field (To Order?) that can be used to flag an RPC call and the operations and communications associated with it as exclusive, and thus indicate this RPC call and the and the operations and communications associated with it should be implemented before the RPC calls and the operations and communications that were logged after the exclusive RPC call.

TABLE 7

| | | | | | |
|---|---|---|---|---|---|
| Call id | Request | To | Client | Reply | Server |
| | | Order? | context | | context |

Table 8 below can be used in the RPC server side. Table 8 is similar to Table 3 above with the addition of an ordered field (To Order?) that can be used to flag an RPC call and the operations and communications associated with it as exclusive, and thus indicate this RPC call and the operations and communications associated with it should be implemented before the RPC calls and the operations and communications that are logged after the exclusive RPC call.

TABLE 8

| | | | | | | |
|---|---|---|---|---|---|---|
| Call | Request | To | Client | Reply | Server | Ack |
| id | | Order? | context | | context | |

It would be appreciated that the enhanced RPC messaging infrastructure or the application programming interface (“API”) that can be implemented according to examples of the presently disclosed subject matter to control and manage communications over interconnect channels in a distributed system, can tolerate two types of failures: a single node (machine) crash and a power outage.

According to examples of the presently disclosed subject matter, in case of a single node crash, the system can be configured to operate in a safe mode until a new node is brought up. Further by way of example, after the new node is brought up, the system can be configured to operate in a recovery mode until the new node is brought up-to-date and the new node's state is consistent with that of existing nodes. Subsequently, the system returns to a normal operating mode.

According to examples of the presently disclosed subject matter, following a power outage, all nodes crash and recover. The nodes may recover with their storage intact, and can resume operation in the normal mode. Or, it would be that only one node or some nodes has/have its/their storage intact, in which case the recovery works as in the node crash scenario described above, for each node whose storage was compromised.

In recovery mode, the goal is to bring the RPC client side temporary store and the RPC server side temporary store to equal states. If only one of the temporary stores is recovered, and the other is empty, the side with the full temporary store can be configured to send all its content to the other side. If one of the sides contains partial information for a certain call ID and the other side contains more information, the one that contains less information is brought up-to-date using data from the side that has the more complete data.

According to examples of the presently disclosed subject matter, in case of recovery of an empty temporary store of an RPC server side, when the temporary store of the RPC server side is refilled from entries from the RPC client side, the following cases can occur: (1) if an RPC request that appeared in the temporary store on the RPC client side without an RPC reply is added, the RPC request can be delivered to the RPC server side as a new request, even though the RPC request may have been delivered before. (2) If the RPC request that appeared in the temporary store on the RPC client side has an RPC reply, the RPC request can be replayed to the RPC server side using a request function replay( ) which includes the RPC request along with its RPC reply, so that the recovery application may learn of RPC requests it processed with their respective RPC replies. In both cases, the RPC server side replies as in the normal mode, and the RPC reply is sent to the RPC client side.

According to examples of the presently disclosed subject matter, in case of recovery of an RPC client side with an empty temporary store, when the temporary store of the RPC client side is refilled from entries from the RPC server side, the following cases can occur: (1) If the RPC request has an RPC reply on the RPC server side, the RPC request is replayed to the RPC client side, and the RPC client side reconstructs the RPC request from the RPC reply or receives it from the RCP client side's interconnect layer, which received it from the RPC server side. (2) If the RPC request does not have an RPC reply on the RPC server side, the interconnect module on the RPC server side can be configured to re-issue the request to the server as a new request (even though it was issued before) and the RPC client side can be configured to await the RPC reply from the RPC server side. Again, the RPC request can be received or reconstructed by the RPC client side when the RCP reply from the RPC server side arrives at the RPC client side.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A method, comprising:
in an RPC client side:
generating an RPC request which corresponds to an RPC call, the RPC request is addressed to an RPC server side and the RPC request includes an RPC call ID;
logging the RPC request in an entry that includes an ID of the RPC call;
in the RPC server side, responsive to receiving the RPC request:
logging the RPC request in an entry including the ID of the RPC call;
generating a respective RPC reply that is addressed to the RPC client side and the RPC reply includes the ID of the RPC call;
logging the RPC reply in the entry that includes the ID of the RPC call; and
in the RPC client side, responsive to receiving the RPC reply:
logging the RPC reply in the entry that includes the ID of the RPC call.

2. The method according to claim 1, wherein further in response to receiving the RPC reply further comprising:
in an RPC client side:
communicating an RPC acknowledgement to the RPC server side including the ID of the RPC call; and
in the RPC server side, responsive to receiving the RPC acknowledgement:
logging the RPC acknowledgment in the entry that includes the ID of the RPC call.

3. The method according to claim 1, wherein the RPC client side and the RPC server side are functional entities in a distributed storage system, and wherein the RPC call is a storage command.

4. The method according to claim 1, wherein in case an RPC call is designated as non-persistent, said logging operations are skipped for that RPC call.

5. The method according to claim 1, wherein in case the RPC call includes an indication that a respective operation is an ordered operation, the entries associated with the ID of the RPC call include an order indication.

6. The method according to claim 1, wherein in case the RPC call is part of a transaction that includes a plurality of RPC calls:
obtaining a context ID that is uniquely associated with the transaction; and
including, in entries that include the ID of any one of the plurality of RPC calls which are part of the transaction, the context ID of the transaction.

7. The method according to claim 1, wherein in case the RPC call is part of a transaction:
in the RPC client side:
generating an RPC request which corresponds to the RPC call, the RPC request is addressed to an RPC server side and the RPC request includes an RPC call ID and a client context ID that is uniquely associated, on the RPC client side, with the transaction which the RPC call is part of;
logging the RPC request in an entry that includes the ID of the RPC call and the client context ID;
in the RPC server side, responsive to receiving the RPC request:
logging the RPC request, the client context ID and the client context ID in an entry including the ID of the RPC call;
generating a respective RPC reply that is addressed to the RPC client side and the RPC reply includes the ID of the RPC call and a server context ID which is uniquely associated, on the RPC server side, with the transaction which the RPC call is part of;
logging the RPC reply and the server context ID in the entry that includes the ID of the RPC call; and
in the RPC client side, responsive to receiving the RPC reply:
logging the RPC reply and the server context ID in the entry that includes the ID of the RPC call.

8. A system comprising:
an RPC client side and an RPC server side running in different processes;
a client temporary storage;
a server temporary storage;
wherein the RPC client side is configured to:
generate an RPC request, the RPC request corresponding to an RPC call, the RPC request is addressed to an RPC server side and includes an ID of the RPC call;
log the RPC request in an entry in the client temporary storage that includes the ID of the RPC call;
wherein the RPC server side is responsive to receiving the RPC request for:
logging the RPC request in an entry in the server temporary storage that includes the ID of the RPC call;
generating a respective RPC reply that is addressed to the RPC client side and the RPC reply includes an ID of the RPC call;
logging the RPC reply in the entry in the server temporary storage that includes the ID of the RPC call; and
wherein the RPC client side is responsive to receiving the RPC reply for:
logging the RPC reply in the entry in the client temporary storage that includes the ID of the RPC call.

9. The system according to claim 8, wherein the RPC client side is further responsive to receiving the RPC reply for communicating an RPC acknowledgement to the RPC server side including the ID of the RPC call, and wherein the RPC server side is responsive to receiving the RPC acknowledgement for logging the acknowledgement in the entry in the server temporary storage that includes the ID of the RPC call.

10. The system according to claim 6, wherein the RPC client side and the RPC server side are functional entities in a distributed storage system, and wherein the RPC call is a storage command.

11. The system according to claim 8, wherein the RPC client side is implemented in a FE of the storage system, and wherein the RPC server side is implemented in a BE of the storage system.

12. The system according to claim 8, wherein the RPC client side is implemented in a first BE node of the storage system, and wherein the RPC server side is implemented in a second BE node of the storage system.

13. The system according to claim 8, wherein the RPC client side is implemented in a FE node of the storage system, and wherein the RPC server side is implemented in a BE node of the storage system.

14. The system according to claim 8, wherein in case an RPC call is designated as non-persistent, the RPC client side and the RPC server side are configured to skip the logging operations for that RPC call.

15. The system according to claim 6, wherein in case the RPC call includes an indication that a respective operation is an ordered operation:
the RPC client side is configured to include in the RPC request an ordered indication, and to include an ordered indication in log entries, in the client temporary storage, which are associated with the RPC call, and
the RPC server side is configured to include in the respective RPC reply an ordered indication, and to include an ordered indication in log entries, in the server temporary storage, which are associated with the RPC call.

16. The system according to claim 8, wherein in case the RPC call is part of a transaction that includes a plurality of RPC calls:
the RPC client side is configured to include in the RPC request a context ID that is uniquely associated with the transaction which the RPC call is part of, and to include the context ID in log entries, in the client temporary storage, which are associated with the RPC call, and
the RPC server side is configured to include in the respective RPC reply a context ID, and to include the context ID in log entries, in the server temporary storage, which are associated with the RPC call.

17. The system according to claim 8, wherein in case the RPC call is part of a transaction:
the RPC client side is configured to:
generate an RPC request which corresponds to the RPC call, the RPC request is addressed to an RPC server side and the RPC request includes an RPC call ID and a client context ID that is uniquely associated, on the RPC client side, with the transaction which the RPC call is part of;
log the RPC request in an entry that includes the ID of the RPC call and the client context ID;
responsive to receiving the RPC request, the RPC server side is configured to:
log the RPC request, the client context ID and the client context ID in an entry including the ID of the RPC call;
generate a respective RPC reply that is addressed to the RPC client side and the RPC reply includes the ID of the RPC call and a server context ID which is uniquely associated, on the RPC server side, with the transaction which the RPC call is part of;
log the RPC reply and the server context ID in the entry that includes the ID of the RPC call; and
responsive to receiving the RPC reply, the RPC client side is configured to:
log the RPC reply and the server context ID in the entry that includes the ID of the RPC call.

18. A program storage device readable by machine, tangibly embodying a program of instructions executable by the machine to perform a method comprising:
in an RPC client side:
generating an RPC request which corresponds to an RPC call, the RPC request is addressed to an RPC server side and the RPC request includes an RPC call ID;
logging the RPC request in an entry that includes an ID of the RPC call;
in the RPC server side, responsive to receiving the RPC request:
logging the RPC request in an entry including the ID of the RPC call;
generating a respective RPC reply that is addressed to the RPC client side and the RPC reply includes the ID of the RPC call;
logging the RPC reply in the entry that includes the ID of the RPC call; and
in the RPC client side, responsive to receiving the RPC reply:
logging the RPC reply in the entry that includes the ID of the RPC call.

19. A computer program product comprising a computer useable medium having computer readable program code embodied therein, the computer program product comprising:
in an RPC client side, computer readable program code for causing the computer to:
generate an RPC request which corresponds to an RPC call, the RPC request is addressed to an RPC server side and the RPC request includes an RPC call ID;
log the RPC request in an entry that includes an ID of the RPC call;
in an RPC server side, computer readable program code responsive to receiving the RPC request at the in an RPC server side for causing the computer to:
log the RPC request in an entry including the ID of the RPC call;
generate a respective RPC reply that is addressed to the RPC client side and the RPC reply includes the ID of the RPC call;
log the RPC reply in the entry that includes the ID of the RPC call; and
in the RPC client side, computer readable program code responsive to receiving the RPC reply for causing the computer to:
log the RPC reply in the entry that includes the ID of the RPC call.
